(19) United States
(12) Patent Application Publication
(10) Pub. No.: US 2003/0120920 A1
(43) Pub. Date: Jun. 26, 2003

(54) Remote device authentication

(76) Inventor: Sven Anders Borje Svensson, San Diego, CA (US)

Correspondence Address: COATS & BENNETT, PLLC, P O BOX 5, RALEIGH, NC, 27602, US

(21) Appl. No.: 10/028,583

(22) Filed: Dec. 20, 2001

(51) Int. Cl. H04L 9/00

(52) U.S. Cl. 713/168; 380/270

(57) ABSTRACT

A wireless local area network authenticates access by a user's device utilizing an authentication key provisioned in another of the user's devices. The network transmits a challenge to the non-provisioned device. The non-provisioned device forwards the challenge to the provisioned device across a wire-based or wireless interface connecting the two devices, such as a BLUETOOTH network link. The provisioned device calculates a response using the authentication key, and forwards the response to the non-provisioned device. The non-provisioned device then transmits the response to the wireless local area network for authentication.

### BACKGROUND OF THE INVENTION

The present invention relates generally to the field of wireless communications and specifically to a method of authenticating one wireless device by using another wireless device.

Wireless access to communication and information services is a recent and growing trend in the telecommunications and data processing industries. Wireless communication services, such as cellular telephone services, have become ubiquitous. Wireless local area networks providing wireless access to computer networks such as the Internet, are also becoming commonplace, particularly in areas frequented by travelers, such as airport lounges, coffee shops, hotels, and the like.

User access to wireless local area networks is typically restricted, such as by subscription, with only subscribed users granted access, or on a pay-per-use basis. In either case, access to the resource is usually only granted following a registration procedure, which typically includes an authentication process to prevent unauthorized or fraudulent access. Additionally, while logged onto the wireless local area networks (even those that do not require registration), users may engage in e-commerce transactions, which may require authentication.

Generally, authentication includes a challenge-response process, in which the wireless service network transmits a “challenge” to the user's device, in the form of a particular code or digital sequence. The device receives the sequence, and generates a “response” utilizing a secret “key” or code. The device sends the response to the network, which compares it against an anticipated response. If the response is proper, the user is authenticated and the registration or transaction proceeds. If the response is incorrect, the network may re-issue one or more challenges, and may eventually deny access to the requested service or transaction if the user's device cannot generate a proper response. Note that the device never directly transmits the key to the network, which would create a security risk, as the key could be intercepted and used fraudulently.

As the number of wireless-enabled devices and wireless services increase, key distribution and management may become problematic. For example, many users already have authentication keys embedded in their cellular radiotelephones. However, the situations described above may require authentication to be performed by a separate device, such as a laptop computer. If the two devices are able to communicate, such as for example over a short-range wireless interface, the cellphone could transmit the key to the laptop. However, this raises serious security concerns since the transmission may be intercepted.

### SUMMARY OF THE INVENTION

The present invention includes a method of authenticating a wireless device to a network challenging the device. The method comprises receiving an authentication challenge from the network at a first wireless device and forwarding the authentication challenge to a second wireless device that contains an authentication key. The second device calculates an authentication response based on the authentication key, and forwards the authentication response to the first wireless device. The first device then transmits the authentication response to the network.

In one embodiment, the present invention includes a method of authenticating a wireless device to a network without knowledge of an authentication key. The method includes receiving at a second network without knowledge of the key, an authentication challenge from a first network with knowledge of the key. The second network issues the authentication challenge to a first wireless device to be authenticated. The second network receives a response from the first wireless device, where the response was calculated by a second wireless device containing an authentication key. The second network forwards the response to the first network and receives an authentication result calculated by the first network based on the response and the first network's knowledge of the authentication key.

### BRIEF DESCRIPTION OF DRAWINGS

FIG. 1 is a functional block diagram showing two wireless communication devices for communicating with two wireless networks;

FIG. 2 is a flowchart depicting an authentication method according to one embodiment of the present invention; and

FIG. 3 is a flowchart depicting an authentication method according to another embodiment of the present invention.

### DETAILED DESCRIPTION OF THE INVENTION

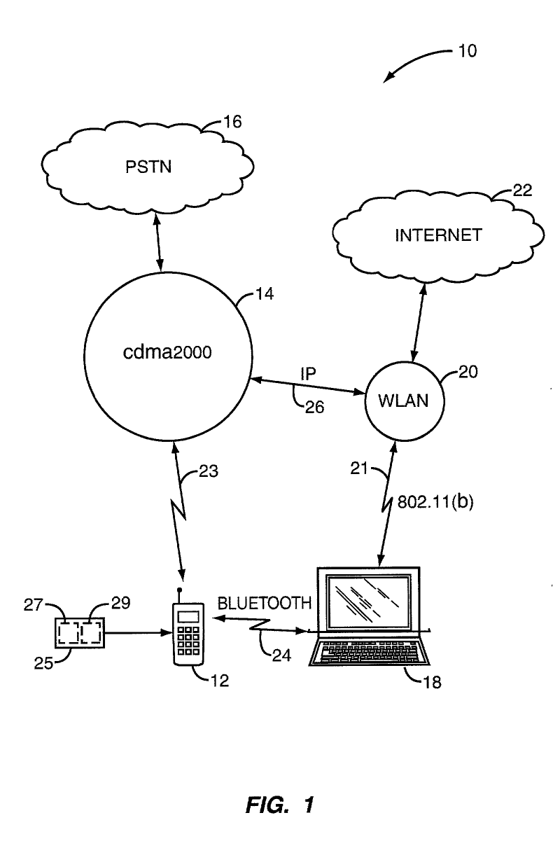

FIG. 1 depicts a functional block diagram of a multi-wireless services environment, indicated generally by the numeral 10. A communication device 12 is wirelessly connected to a first wireless network 14, such as a wireless communication network, which is in turn connected to the Public Switched Telephone Network (PSTN) 16. A computing device 18 is wirelessly connected to a second wireless network 20, such as a Wireless Local Area Network (WLAN), which is in turn connected to one or more computer networks such as the Internet 22.

The communication device 12 may comprise a cellular radiotelephone; a Personal Digital Assistant (PDA) that may combine a cellular radiotelephone with data processing, facsimile and data communications capabilities; or a card that inserts into computing device 18. The communication device 18 is represented in FIG. 1 as a cellular radiotelephone with a cellular radio interface 23 to communicate with a wireless communication network 14. The computing device 18 may, for example, comprise a portable computer (variously known as a laptop, notebook, palmtop, or the like), a PDA, or similar device with a microprocessor. The computing device 18 includes a WLAN interface 21, which may for example be an 802.11(b) interface, to communicate with the WLAN.

Both the communication device 12 and the computing device 18 include a second interface 24, which in the disclosed embodiment is a wireless interface, that allows the communication device 12 and computing device 18 to communicate with one another. A common wireless interface used for short-range communications is the BLUETOOTH interface. Other wireless interfaces could also be used, such as an infrared interface or other radio interface. The communication device 12 and computing device 18 could also be coupled via a wire, cable or optical fiber. As will be described in more detail below, the second interface 24 allows the computing device 18 to utilize secret information stored in the communication device 12 to access the WLAN 20.

The wireless communication network 14 connects communication device 12 with other communication devices (not shown), and with terminals connected to the PSTN 16, over one or more communication channels. A channel may comprise a frequency, a timeslot, a CDMA code, a frequency hopping pattern or any combination of these, depending on the radio air-interface standard in use. Representative standards include Time Division Multiple Access (TDMA) standards such as the Telecommunications Industry Association (TIA)/Electronics Industry Alliance (EIA) standard TIA/EIA-136, or the Global System for Mobile Communication (GSM); Code Division Multiple Access (CDMA) standards such as IS-95, cdma2000, and Wideband CDMA (W-CDMA); or a broad variety of other wireless communications technologies and protocols, such as the Universal Mobile Telecommunications System (UMTS). While wireless communication network 14 is explicated herein with reference to the cdma2000 standard, the present invention is not thus limited, and may be implemented by one of skill in the art in a wide variety of wireless communication networks.

The Wireless Local Area Networks (WLANs) 20 provides high-bandwidth data communications to appropriately equipped computing devices 18. WLANs 20 may be implemented according to a variety of protocols and technical standards, such as for example, IEEE 802.11(b) (also known as “Wi-Fi”); the short-range wireless ad hoc network developed and promulgated by Telefonaktiebolaget L. M. Ericsson, known commercially as BLUETOOTH; IEEE 802.11(a); or HiperLAN/2. WLAN 20 may illustratively be based on the IMT-2000 standard, and may conform to the Wireless IP Architecture as described in publication TIA/EIA/TSB-115, incorporated herein by reference in its entirety.

WLAN 20 is characterized by high bandwidth data communications and limited geographic extent of coverage. WLAN 20 may be deployed for private use within offices, universities, laboratories, and the like, and for public use in airport lounges, coffee shops, hotels, and the like. WLAN 20 may additionally be deployed over wider areas, such as a university campus, or several city blocks. Two or more WLANs 20 may be interconnected to provide high-bandwidth data communications over a metropolitan area. The areas covered by WLAN 20 typically form islands surrounded by areas with no such service. These islands are commonly referred to as “hot spots.”

WLAN 20 may be provided by the same service provider as the communication network 14, or alternatively, WLAN 20 may be provided by independent service providers, such as Wireless Internet Service Providers (WISPs) or site operators. User access to the WLAN 20 may be restricted, such as for example, by subscription with only subscribed users granted access. Alternatively, access to the WLAN 20 may be open to the general public, either on a pay-per-use basis or without billing, such as to induce customers to patronize an establishment. Users of restricted access WLAN 20 must register with the WLAN 20 prior to accessing its services, which registration process may include a challenge-response procedure. In addition, pay-per-use users may be authenticated periodically, also using a challenge-response procedure. Regardless of the access model or need for registration, all users may be required to authenticate their identities to the WLAN 20 at various times, such as to engage in e-commerce transactions within the WLAN 20 or other networks accessed through it.

The challenge-response paradigm of authentication is well known in the cryptographic and data security arts, and has been implemented in several defined standards, such as for example the Challenge Handshake Authentication Protocol (CHAP). CHAP is based on one or more “keys” issued to the user to be authenticated. A key may for example comprise a number, an alphanumeric string, or a digital code. The key is maintained in strict secrecy, and is known only to the user and the network that performs authentication. In other implementations, such as within a Public Key Infrastructure (PKI) based system, two mathematically related keys are associated with each user—a private key that the user keeps secret, and a public key that is published or transferred to the party or network to whom the user is to be authenticated. The present invention addresses any challenge-response authentication protocol, including for example both CHAP and PKI based systems.

Where authentication is always performed via a device, such as for example, authenticating a user in a cellular wireless communication network 14, the key (at least the private key, in a PKI environment) may be programmed directly into the user's access device, such as his or her cellular radiotelephone 12. The communication device 12 with a key programmed therein is referred to as a “provisioned” device 12; and the wireless computing device 18 without a key is “non-provisioned” device. Provisioning a device 12 with a key increases security and is convenient to the user, who need not enter the key for authentication every time the user accesses the wireless communication network 14. For security, the key is maintained in secret, and for example is not transmitted to or from the communication device 12 in a non-encrypted format. The key may be stored for example, in a secure authentication unit 25, such as a removable, tamper-resistant smart card that includes both memory 27 for storing secret information and a processor 29 for performing cryptographic calculations with the secret information.

Authentication is described herein, by way of explanation and without limitation, as it occurs between a user's communication device 12 and the wireless communication network 14 (assuming the communication device 12 is a provisioned device). Authentication centers on the user's key. The key may, for example, comprise a 64-bit secret pattern assigned and stored in permanent memory in the provisioned device 12. The provisioned device 12 is additionally identified by an Electronic Serial Number (ESN), which is a 32-bit binary number that uniquely identifies the provisioned device 12 to any wireless network 14. The ESN is encoded into the provisioned device 12 at the factory and is not readily alterable in the field; modification of the ESN requires a special facility not normally available to users.

Both the wireless network 14 and the provisioned device 12 generate identical Shared Secret Data (SSD). The SSD is a 128-bit pattern stored in the semi-permanent memory 27 of the provisioned device 12, and is maintained during power-off. The SSD may be generated using a 56-bit random number RANDSSD created and transmitted by the wireless network 14, the user's key, and the ESN of the provisioned device 12.

During a challenge-response authentication procedure, the network 14 issues a “challenge” to the wireless device 12 attempting to access the wireless network 14. The challenge may for example comprise a 32-bit random number RAND. The provisioned device 12 calculates a “response,” which may comprise an encrypted version of RAND, using a portion of the SSD. The provisioned device 12 then transmits the response to the network 14. Neither the user's key nor the SSD is transmitted between the provisioned device 12 and the network 14, for security. The network 14 performs the same calculation, using RAND and the SSD associated with the particular provisioned device 12, and confirms the identity of the provisioned device 12 by comparing its expected response with the response transmitted by the provisioned device 12.

In a similar fashion, a challenge-response authentication process may occur between a WLAN 20 and a user's computing device 18 (either as part of registration with the WLAN 20 or to engage in e-commerce transactions, such as on the Internet 22). The user's key may be programmed into the computing device 18, or may be attached thereto, such as through a Personal Computer Memory Card International Association (PCMCIA) interface. In many situations, however, the user would prefer to maintain only one key. For example, the WLAN 20 may be operated by the service provider supplying the wireless communication network 14. In this case, the WLAN 20 will allow the user to access the WLAN 20 without a prior service agreement if the wireless network 14 authenticates the user. This requires signaling between the WLAN 20 and the wireless network 14. In this case, the user may desire for all of his access charges—associated with the WLAN 20 as well as with the wireless network 14—to be tracked and billed under the same account. A similar situation may result when the WLAN 20 is operated by an independent service provider, but one that has a reciprocal billing arrangement with the operator of the wireless network 14. The use of one user key may be advantageous or desirable for other reasons. For example, a user may wish to access a WLAN 20 for personal reasons on a company computing device 18, and may prefer his access charges and e-commerce transactions to be billed to his wireless network 14 account, even if the computing device 18 has a separate key.

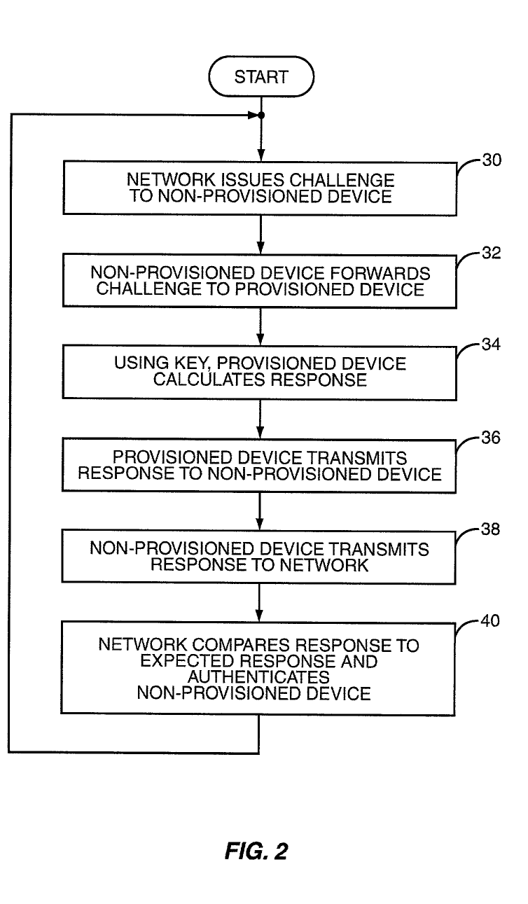

Communication devices 12 and computing devices 18 are increasingly equipped with advanced communication capabilities. In particular, many devices 12, 18 include interfaces that allow for the creation of Wireless Personal Networks (WPN). One example of such interfaces is the BLUETOOTH® wireless technology. The BLUETOOTH standard and protocol describe the creation of short-range, wireless, adhoc networks for data communication among a variety of disparate devices 12, 18. The BLUETOOTH wireless technology is further described in “An Overview of the Bluetooth Wireless Technology” by Chatschik Biskikian, IEEE Communications Magazine, Vol. 39, No. 12, p. 86 (December 2001) incorporated herein by reference in its entirety. The BLUETOOTH interface 24 between the user's communication device 12 and computing device 18 is shown in FIG. 2. While one straightforward solution to the above described problems may seem to be simply transmitting the user's key from the communication device 12 to the computing device 18 across the BLUETOOTH link 24, for the calculation of a response at the computing device 18, this poses a severe security risk, as it requires the key to be transmitted on an open wireless data link, where it is subject to interception and subsequent fraudulent use.

The remote authentication method of the present invention solves the problem of authenticating non-provisioned devices 18 that can communicate with a provisioned device 12, and is explained with reference to the flowchart of FIG. 2. According to the present invention, when the non-provisioned device, in this case the computing device 18, receives an authentication challenge from the WLAN 20, such as, for example, across an IEEE 802.11(b) interface (block 30), the non-provisioned device 18 transmits the challenge to the provisioned device, in this case the communication device 12 (block 32). The provisioned device 12 then calculates an authentication response based on the user's key (block 34), and transmits the authentication response to the non-provisioned device 18, such as across the BLUETOOTH link 24 (block 36). The non-provisioned device 18 then transmits the response to the WLAN 20, such as across the IEEE 802.11(b) interface (block 38), which compares the received authentication response to an expected authentication response to complete the authentication procedure (block 40). In this manner, the provisioned device 12 may authenticate any number of non-provisioned devices 18, all using the single key contained in the user's provisioned device 12.

The method depicted in FIG. 2 and described above assumes that the key contained in the provisioned device 12 is known to the service network (e.g., the WLAN 20) authenticating the non-provisioned device 18, or that the service network has a related key, such as the user's public key in a PKI environment. This may be the case, for example, if the WLAN 20 is hosted by the operator of the wireless communication network 14. However, the WLAN 20 may be hosted by a third party, such as for example a WISP. In this case, to authenticate the user via the user's key in the provisioned device 12, the WLAN 20 must additionally communicate with the wireless communication network 14. This may occur over the link 26 depicted in FIG. 1, which may comprise an IP network, an SS7 signaling link, a dedicated T1/E1 trunk, or the like.

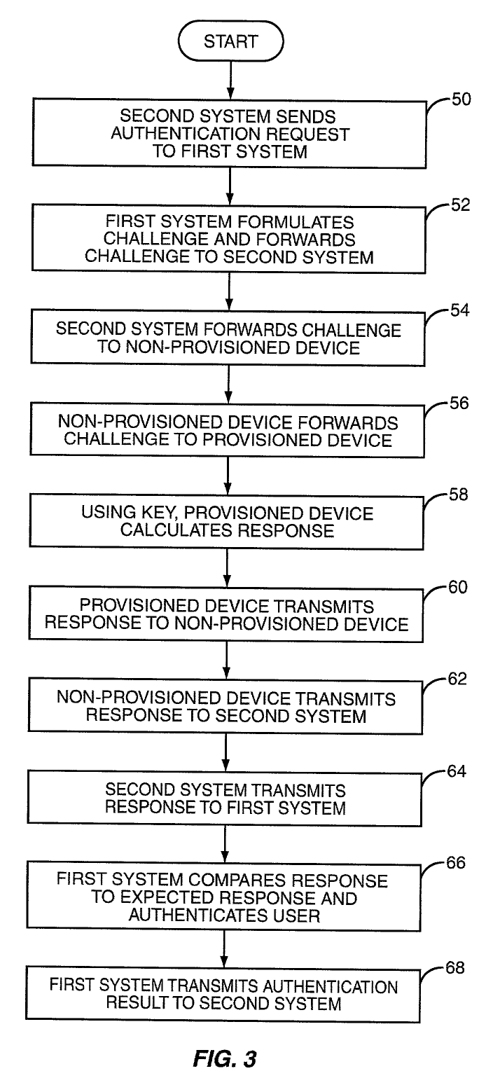

A method of authenticating a user without knowledge of the user's key is depicted in the flowchart of FIG. 3. The WLAN 20 requiring authentication is referred to as the secondary network, and the wireless communication network 14, with knowledge of the user's key, is referred to as the primary network. When a user attempts to log onto the secondary network 20, (or authorize an e-commerce transaction on the secondary network 20), the secondary network 20 sends an authorization request to the primary network 14 (block 50), identifying the user (such as, for example, based on identifying information provided during the registration procedure). The primary network 14, with knowledge of the user's key or a related key, formulates an authentication challenge and transmits the challenge to the secondary network 20, (step 52). The secondary network forwards the challenge to the non-provisioned device 18 (block 54), which in turn transmits the challenge to the provisioned device 12 (block 56). The provisioned device 12 then calculates a response based on the user's key (block 58), and transmits the response to the non-provisioned device 18. The non-provisioned device 18 then transmits the response to the secondary network 20 (block 62). The secondary network 20 in turn transmits the response to the primary network 14 (block 64). The primary network 14 compares the response to an expected response, thus performing authentication of the user (block 66). The primary network 14 then transmits the result of the authentication to the secondary network 20 (block 68), and based on the result, the secondary network 20 completes the registration, approves the transaction, initiates a re-try, or takes other action with respect to the non-provisioned device 18, as appropriate.

Although the present invention has been described herein with respect to particular features, aspects and embodiments thereof, it will be apparent that numerous variations, modifications, and other embodiments are possible within the broad scope of the present invention, and accordingly, all variations, modifications and embodiments are to be regarded as being within the scope of the invention. The present embodiments are therefore to be construed in all aspects as illustrative and not restrictive and all changes coming within the meaning and equivalency range of the appended claims are intended to be embraced therein.

What is claimed is:

1. A method of authenticating a wireless device for accessing a first wireless network challenging said device, comprising:
receiving an authentication challenge from said first wireless network at a first wireless device;
forwarding said authentication challenge from said first wireless device to a second wireless device storing an authentication key;
calculating an authentication response based on said authentication key at said second wireless device;
forwarding said authentication response from said second wireless device to said first wireless device; and
transmitting said authentication response from said first wireless device to said first wireless network.

2. The method of claim 1 wherein said second wireless device is a wireless communication mobile terminal.

3. The method of claim 1 wherein receiving said authentication challenge and transmitting said authentication response occur across a wireless communication interface.

4. The method of claim 3 wherein said wireless communication interface is a wireless local area network interface.

5. The method of claim 1 wherein forwarding said authentication challenge and forwarding said authentication response occur across a communication interface connecting said first and second wireless devices.

6. The method of claim 5 wherein said communication interface is a wire or optical cable interface.

7. The method of claim 5 wherein said communication interface is a wireless communication interface.

8. The method of claim 7 wherein said wireless communication interface is an optical interface.

9. The method of claim 7 wherein said wireless communication interface is a radio frequency interface.

10. The method of claim 9 wherein said radio frequency interface is a BLUETOOTH interface.

11. The method of claim 1 wherein said authentication key is a private key, and wherein said authentication challenge is generated based on a public key associated with said private key.

12. The method of claim 1 wherein calculating an authentication response based on said authentication key comprises performing a mathematical operation on said authentication challenge using said authentication key to obtain said authentication response.

13. The method of claim 1 further comprising authenticating said first wireless device by said first wireless network based on said authentication response.

14. The method of claim 13 wherein said authentication key comprises a shared key known to said first wireless network.

15. The method of claim 14 wherein authenticating said first wireless device by said first wireless network comprises:
using said authentication challenge and said shared key to compute an expected authentication response at said first wireless network; and
comparing said expected authentication response with the actual authentication response received from said first wireless device.

16. The method of claim 13 wherein said authentication key is a private key known only to the second wireless device, and wherein said private key has a corresponding public key that is known to the first wireless network.

17. The method of claim 16 wherein said first wireless network encrypts a data pattern using said public key to generate the authentication challenge, and wherein authenticating said first wireless device by said first wireless network further comprises comparing the authentication response to the original data pattern used to generate the authentication challenge.

18. The method of claim 17 wherein calculating an authentication response based on said authentication key comprises decrypting said authentication challenge to obtain the data pattern.

19. The method of claim 14 further comprising:
generating said authentication challenge at a second wireless network;
forwarding said authentication response from said first wireless network to said second wireless network; and
authenticating said first wireless device by said second wireless network based on said authentication response.

20 The method of claim 19 further comprising:
sending an authentication result from the second wireless network to the first wireless network; and
providing or denying access for the first wireless device to the first wireless network based on said authentication result.

21. The method of claim 19 wherein said authentication key comprises a shared key known to said second wireless network.

22. The method of claim 21 wherein authenticating said first wireless device by said second wireless network comprises:
using said authentication challenge and said shared key to compute an expected authentication response at said second wireless network; and
comparing said expected authentication response with the actual authentication response received from said first wireless network.

23. The method of claim 19 wherein said authentication key is a private key known only to the second wireless device, and wherein said private key has a corresponding public key that is known to the second wireless network.

24. The method of claim 23 wherein said second wireless network encrypts a data pattern using said public key to generate the authentication challenge, and wherein authenticating said first wireless device by said second wireless network further comprises comparing the authentication response to the original data pattern used to generate the authentication challenge.

25. The method of claim 19 wherein said second wireless network is a wireless communication network.

26. A wireless device comprising:
a first interface to communicate with a wireless network;
a second interface to communicate with a provisioned wireless device having an authentication key used to access the wireless network;
a microprocessor connected to said first and second interfaces and programmed to:
forward an authentication challenge received from the wireless network via said first interface to the provisioned wireless device via said second interface;
receive an authentication response from the provisioned wireless device via said second interface; and
forward the authentication response via said first interface to the wireless network.

27. The wireless device of claim 26 wherein the first interface is a WLAN interface.

28. The wireless device of claim 26 wherein the second interface is wireless interface.

29. The wireless device of claim 28 wherein the second interface a radio frequency interface.

30. The wireless device of claim 29 wherein the second interface is a BLUETOOTH interface.

31. A wireless device having an authentication key used to access a wireless network comprising:
an interface to communicate with a non-provisioned wireless device;
an authentication unit connected to said interface and having a memory for storing the authentication key and a processor for performing calculations using said authentication key, said authentication unit being operative to:
receive an authentication challenge via said interface from the non-provisioned wireless device attempting to access the wireless network,
compute an authentication response using the authentication challenge and the authentication key; and
forward the authentication response via the interface to the non-provisioned wireless device to be used by the non-provisioned wireless device to access the wireless network.

32. The wireless device of claim 31 wherein the interface is a wireless interface.

33. The wireless device of claim 32 wherein the interface a radio frequency interface.

34. The wireless device of claim 33 wherein the interface is a BLUETOOTH interface.
